(19) United States
(12) Patent Application Publication
(10) Pub. No.: US 2005/0053908 A1
(43) Pub. Date: Mar. 10, 2005

(54) Education management system, method and computer program therefor

(75) Inventors: Gorintla Satheesh, Secunderabad (IN); Suresh Sundaram, Gurgaon (IN)

Correspondence Address: NIXON & VANDERHYE, PC, 1100 N GLEBE ROAD, 8TH FLOOR, ARLINGTON, VA, 22201-4714, US

(73) Assignee: EAZY SOFTECH PRIVATE LIMITED, Haryana, IN (US)

(21) Appl. No.: 10/653,906

(22) Filed: Sep. 4, 2003

(51) Int. Cl. G09B 3/00

(52) U.S. Cl. 434/350

(57) ABSTRACT

The present invention relates to an education management system and method therefor. The present invention also relates to a computer program for monitoring the progress of tutors and students in a classroom environment.

### FIELD OF THE INVENTION

The present invention relates to an education management system and method therefor. The present invention also relates to a computer program for monitoring the progress of tutors and students in a classroom environment.

### BACKGROUND OF THE INVENTION

Educational systems across the world have developed over a period of time from individualistic interaction between the tutor and student to a standardized system of learning. Most educational institutions now follow a standard protocol and syllabi in imparting education to their students. Another significant development in the field of education has been the creation of distance learning as a mode of imparting education. For example, an institution based in one city has students across the country and in some cases across the world who study the same curricula. Other examples of developments in the field of education has been the decentralization of education in that an institution has several branches across a geographical territory, with different tutors but following the same syllabi. Example of this mode of teaching include management institutes and higher institutes of learning in medicine, law and engineering wherein while the syllabi and teaching protocol may be identical across different branches of the same institution, the actual tutors differ from place to place. This method of education has tremendous value in ensuring access to education across a country or any geographical territory, without requiring either the tutors or the students to travel long distances from their residences.

Another significant development in technology which has benefited standardization in education is the use of the Internet or the world wide web or local area networks to impart education to students across different locations at the same real time. In the ancillary field of educational testing for entrance to various institutions of higher learning, the use of the Internet and dedicated web sites for imparting tutorials is fast gaining acceptance across the world. The value of the use of the computer based teaching system across different locations can be understood by the simple example of a student residing in any city in India being able to participate in scholastic assessment programs conducted by universities in the United Kingdom or in the United States of America at the ‘click’ of a mouse.

However the growth of standardization in education syllabi and protocols have not been accompanied by a similar standardization in teaching techniques of individual tutors. Thus, different tutors will possess different teaching techniques and as a result their effectiveness may also vary. This is critical especially since a lot of outsourcing of education to third parties (franchisees) is now taking place. The initial training of tutors on the recommended method of teaching may not be adequate and regular evaluation may be required especially as the course content/syllabi or teaching methodology may change. The performance of individual tutors has to be monitored to maintain consistency.

Several attempts have been made to create an efficient classroom management and student score comparison system. Examples include various online testing and scoring systems. It is also known in the art to enable students who intend applying to various educational institutions to participate in online tutorials intended to introduce and familiarize the students with the specific educational standards and questions that the institution normally includes in the entrance tests. Several systems exist wherein home based testing, scoring and self assessment capability is provided to students. These also sometimes include the capability for participants to compare their scores with scores of other participants.

The effectiveness of tutors can be gauged by the actual scores or percentiles obtained by their respective students in any of the tests administered during the educational program. However, very little attention has been given to this aspect in computer based learning programs. An example of where such evaluation would be effective is the case of scholastic assessment tests such as the GMAT, GRE, LSAT or SAT. Several organizations provide specialized tutorials to students who aspire to write these tests. Such organizations may typically have a plurality of centers across a country, each center having a plurality of students and dedicated tutors. In such cases, in order to provide full justice to the students it is essential that the institution/organization maintain a certain level of standardization in not only the syllabi and actual tests administered, whether online or not, but also in terms of the teaching techniques. Standardization of teaching techniques is important as this will enable students to obtain a reasonably accurate evaluation of their own capability and aptitude for such programs.

Similarly, tutor effectiveness also requires evaluation so as to maintain consistency in standards of teaching across all centers and also so as to ensure that the students enrolled get the optimum benefit of the tutorials. Therefore, evaluation of tutor effectiveness is also important for the organization conducting the tutorial in order to improve its services.

Such evaluation techniques can include collection of student performance data from various centers, analysis of tutor and teaching technique effectiveness using the above data, in order to obtain, inter alia, a reasonably accurate evaluation of the course content. However, very few such systems exist for tutor evaluation.

One of the significant problems faced in such evaluation methods is that it is difficult to evaluate a question asked in a test based on student performance and analyze the specific tutor performance based on the student performance. Such a procedure would require the use of a panel of independent experts (say three or four) who will assess the levels independently, and arrive at a conclusion based on their reports. This method is however not foolproof, particularly in the case of standardized tests and programs, since each independent evaluator's assessment is based on his or her subjectivity.

The data obtained from the performance of the students during the course can be used to evaluate the performance of tutors and the course content and based on the evaluation, make appropriate changes to the course content.

It is therefore important to devise a system and method whereby such evaluation can also be standardized to obtain a reasonable degree of objectivity in the evaluation itself.

Another example would be a company with offices around the world. The training given to employees across the world may have to be monitored and the instructors trained and evaluated accordingly.

### OBJECTS OF THE INVENTION

The main object of the invention is to provide an education management system, which enables contemporaneous evaluation of student and tutor performance.

It is another object of the invention to provide a method for tutor evaluation in a classroom environment, which is substantially objective and is based on student performance and has a high degree of standardization of evaluation parameters.

It is yet another object of the invention to provide a method and system for contemporaneous tutor and student evaluation which is applicable across a host of different classroom environments, whether online education or in real time classroom situations.

It is another object of the invention to provide a method and system for contemporaneous tutor and student evaluation applicable across different classroom environments, which utilizes computer based evaluation in order to maintain standardization in evaluation parameters and avoid subjectivity in evaluation.

It is another object of the invention to provide a method and system for assessment and evaluation of the course content based on the data collected of performance of students.

### SUMMARY OF THE INVENTION

Accordingly, the present invention relates to an education management system and method therefor. The present invention also relates to a computer program for monitoring the progress of tutors and students in a classroom environment.

The term ‘classroom’ as used herein is intended to cover several different situations including actual physical teaching in a real time classroom environment, whether in an educational institution or in an organization/institution which provides tutorials for entrance tests/scholastic aptitude tests for such institutions. The term is also intended to cover situations where the Internet, or any other network, is used as an educational aid in imparting education by various educational institutions or tutorials/tests conducted by organizations/institution which provides tutorials for entrance tests/scholastic aptitude tests for such institutions.

The system of the invention enables the monitoring of progress of students, effectiveness of tutors and evaluation of individual teaching techniques as well as course content based on the results of the students in their classes using a computer based testing and score reporting and comparison system. The system of the invention receives data from the practice exercise/testing software installed in student's computers, including information about the number of questions, type of questions, questions answered correctly, scores, time taken to answer each question and related information such as demographics and the like. This information is stored in the main system database and the stored data enables system administrators to compare, monitor and create feedback, either manually or automatically, for various tutors and students as well as assess course content, teaching techniques and level of questions used in the testing system.

An important feature of the invention is that the tests can be administered offline and do not require regular and continuous online access. This is of great importance in countries such as India, where connectivity to the Internet is still largely through dial up connections using a telephone and a modem and where access to the Internet is dependant on the level of traffic on the system. The data is stored and uploaded in a coded format to minimize the upload time and Internet connectivity.

### BRIEF DESCRIPTION OF THE ACCOMPANYING DRAWINGS

FIG. 1 is a block diagram of the system of the invention depicting the various components of the system and its requirements.

FIG. 2 is a block diagram of another embodiment of the invention depicting the administration control over the evaluation process by which standardization of evaluation parameters and thus objectivity in tutor evaluation is attained.

FIG. 3 is a block diagram of another embodiment of the invention depicting a situation comprising multiple centers within the same city or in different cities, each center with a plurality of students and one tutor.

### DETAILED DESCRIPTION OF THE INVENTION

The present invention accordingly provides an education management system which enables tutor and learning evaluation based on the collection of student performance data from different classes, analysis of such data to compare performance across various classes, performance over a period of time and enables assessment of the level of the test questions.

The invention will now be explained with reference to the accompanying illustrative drawings and should not be construed as limiting the scope of the invention in any manner.

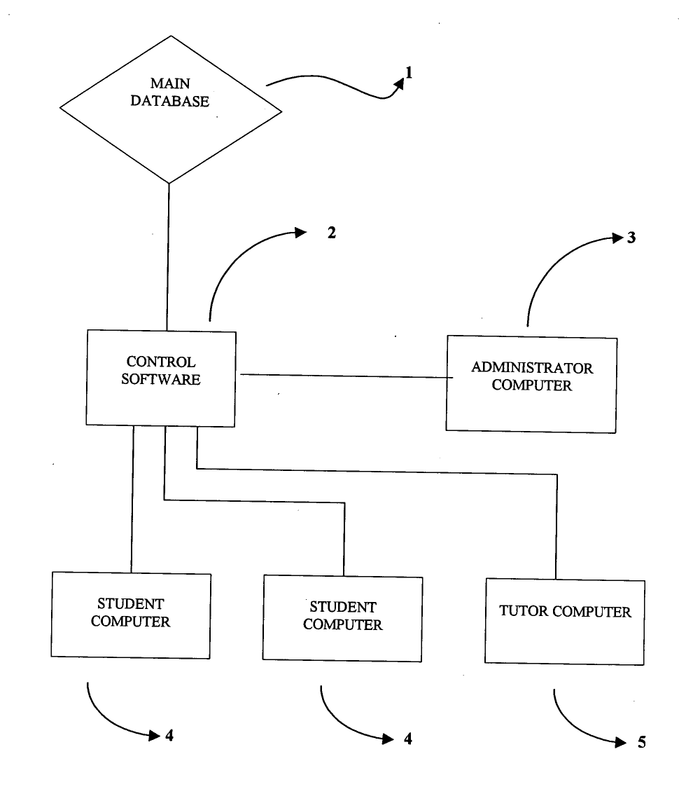

FIG. 1 is a block diagram of the system of the invention depicting the various components of the system and its requirements.

Referring to FIG. 1, the following constitute the minimum system requirements: an administrator computer (3) connected through a control software (2) to a main database (1) which is in turn connected to at least one tutor computer (5) and at least one student computer (4) through the control software (2).

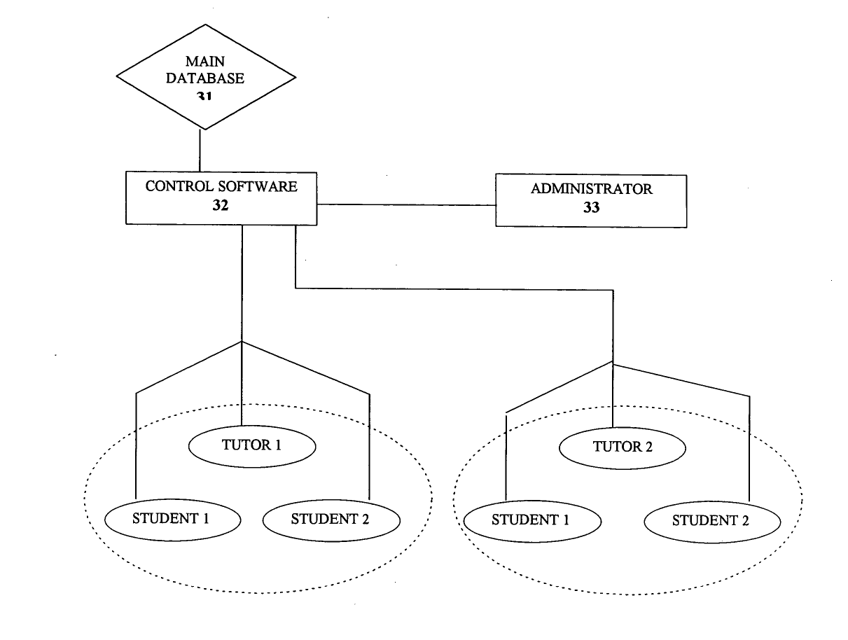

The computer hosting the main database (1) is provided with database control software (2) having recognition capability in terms of all elements of the system—administrators, tutors and students, on the specific network. It must be understood that though FIG. 1 depicts only one tutor computer and two student computers, a plurality of tutor computers and respective student computers can be present in the network, as shown in FIG. 3.

The same method as depicted in FIG. 1 can also be applied across a plurality of centers whether within the same geographical location or across different geographical locations, each such center having a plurality of students and at least one tutor. The method of the invention is particularly useful in this scenario since it enables evaluation of tutors as well as receptiveness to course content across different locations with students of different backgrounds and educational aptitudes. This enables the improvement of the course content according to the needs of the students even as the course is being conducted such that optimum benefit is provided to the students.

An important feature of the system of the invention is that the student computer and the tutor computer are not required to communicate directly. In fact, all communication between the student and the tutor during the educational program is through the control software (2) after securing a preliminary authentication from the administrator (3).

The student computer (4) can be either a dedicated testing computer provided in a real time classroom environment or at any remote point. Similarly, the tutor computer (5) can also be either a dedicated computer in a real time classroom environment or at any remote point.

A fundamental requirement of the system of the invention is that there exist connectivity across the network. This can be through the Internet or through any local area network or Intranet.

When a student desires to enroll in the program, the administrator provides a diagnostic test which is also standardized in order to assess the level of the student. The diagnostic test scores are stored in the main database. Based on the students' performance in the diagnostic test, the administrator assigns the student to a particular tutor. As is therefore evident, it is not required that the student and the tutor reside in the same city. The needs of a particular student may be best met by a tutor in a different city. The use of networking and non-direct communication between the student and the tutor ensures that the requirements of the student are met in the most optimal manner. Another important advantage of the system of the invention is that a plurality of tutor and student combines (also referred to herein as ‘classes’) can be present across the same network, thereby enabling comparative evaluation of the tutors.

The method of the invention will now be further described with reference to specific classroom environment where it is applicable, for example scholastic aptitude tests such as GMAT for admission to institutes of higher learning abroad. In this scenario, the underlying assumption for applicability of the system, method and computer program of the invention is that an organization offers tutorials for GMAT across a plurality of cities, with at least one center in each city. Another underlying assumption is that the tutorials are conducted online or over the Internet, wherein the student possesses a computer system and software which enables the student to download the tutorial content as well as tests based thereon and partake in the program offline. For example, the student will be enabled to download the tutorial and study the syllabi offline. For further interaction with the dedicated tutor, the student can return online, seek clarifications for any questions or doubts. The student can also download the tests, go offline, answer the tests, and upload the data subsequently.

This case is just a specific example and the system is equally suitable for organizations running one or more classes in one or more cities. The only requirement of the system is that there has to be at least one tutor and two students for the system to work.

The system administrator can use the system of the invention to monitor the performance of students and tutors across all the centers. In one exemplary embodiment, the administrator allocates a username and password to each tutor. This is the username and password that the tutor can use to login and use the tutor administration module. The username and password are either generated manually by the administrator or can be automatically generated once the administrator enters the tutor's details like name, center number, e-mail, address or any other information. The administrator can also restrict the number of students allocated to any particular tutor.

When a student joins the preparation program offered by the organization, the student is given a diagnostic test in order to analyze the standard of the student at the time of joining the program. The student can take the diagnostic test on a designated computer in a class or on a remote computer. Based on the result of the test, the administrator can allocate the student to a particular class. For instance, if the student is weaker in Math, he is allocated to a class where students, in the past have shown improvement in math. This ensures that the student is taught in a class where his weak areas get better preparation. Thus, using the system helps the administrator to allocate the student to a class, where he will obtain the maximum benefit.

On allocation to a particular class, the student is given a username and password. This can again be generated either automatically or manually. Usernames are generated to associate the student with the allocated tutor. The usernames of students allocated to a class and the tutor of the class are closely linked. For instance if the tutor is allocated a username of ‘11001’, the username generated for the students can be ‘11001001’ or ‘11001002’. This helps the system recognize the class of a student without entering the data separately and also helps in reducing database size and speed of recovery of data. It also helps in reducing the size of the upload which is crucial in this system.

Along with the username and password, the student is given the exercise/testing software. This can be given in either a computer recordable media such as a CD or floppy diskettes or can be downloaded by the student from the organizations' web site. This software consists of a series of tests/exercises/assignments that a student has to take during the program. For instance, a student has taken a six-month program, the student can be given test/exercises/assignments every 15 days to monitor his/her progress and to test the student's knowledge. So, in this case, the testing software will have 12 tests/exercises/assignments which need to be either downloaded by the student or obtained on a computer recordable media such as a CD or floppy diskettes.

The practice exercise/test software contains the list of practice questions, uses adaptive/non-adaptive technology to offer the right questions to the students and an internal scoring mechanism to score the test as well as register all details of the results like time taken to answer each question, percentage of questions answered right, levels of questions answered right. The details are stored in form of a coded format to ensure minimum upload time. This is important in countries where the net connectivity is weak. The questions, answers and other related information are uploaded in coded format to reduce the upload time.

The test can be taken offline or online and a student needs to connect to the net just for authentication as well as to upload scores. The authentication can either be done online or offline, depending on the requirements of the class and students. The test results are then uploaded to the main database using the control software. The control software accepts the results and stores it in the database in the required and specified format.

The data of all students stored in the main database allows the administrator to compare the progress of students in each class using the control software. For instance, the improvement of average scores of students in test 2 over test 1 in class may be 10% greater than in class B. If this improvement is consistent over a period of time, it is an indicator to the administrator that the tutor or teaching technique used in class A is better than that of class B.

Similarly, the statistics can guide the administrator to evaluate the type and level of questions. For instance, the administrator can list the question with a higher number of incorrect answers or where significantly larger amounts of time was taken by the students and can guide the tutors accordingly.

For example, the administrator can note that a particular type of reading comprehension question is problematic for students in one country, while students in another country find Math questions relatively more difficult. This enables the administrator to modify the program content in these countries in order to focus on the weaker areas of student performance.

The administrator can obtain all the required data in the form of statistics from the main system database and generate reports using the control software for all the centers across a country. This also enables change of tutors at a center and monitoring the subsequent results to check if there is any change in the performance of the students. The administrator can also compare results of two different periods, say two different years and measure the improvement.

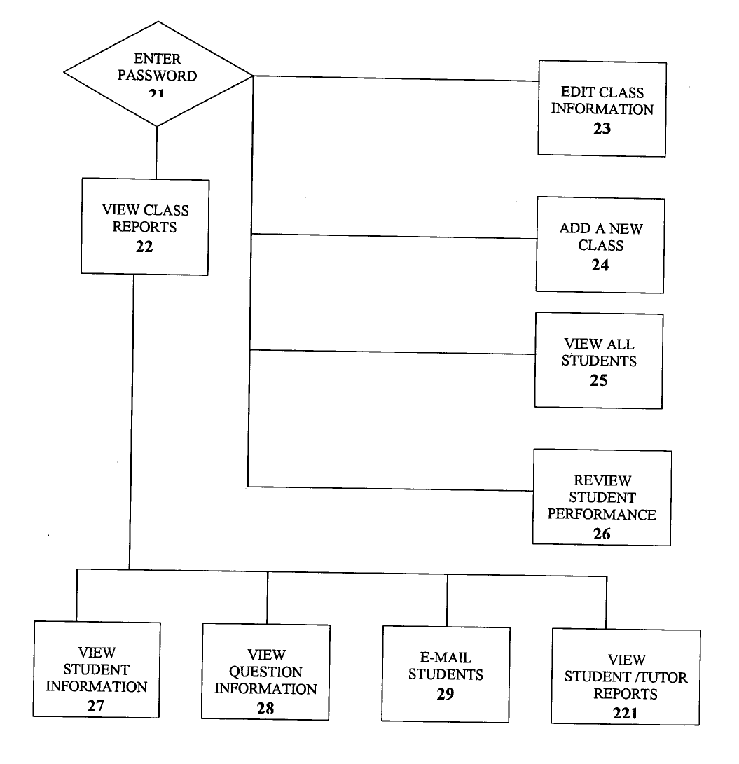

FIG. 2 is a block diagram of another embodiment of the invention depicting the administration control over the evaluation process and various functionalities by which standardization of evaluation parameters and thus objectivity in tutor evaluation is attained.

The administrator is provided with various functionalities in the control software which enable the administrator to monitor the system and perform the desired tasks. The administrator may be permanently linked to the main database or can also be provided with conditional access depending on the entry of a specific identification protocol including a username and password. The latter option provides for greater security in terms of preserving data obtained from the various student and tutor computers across the network. On entering a password (21, FIG. 2), the administrator can select any one of the required tasks using any standard operating protocol such as drop down menus, and the like. Some of the required tasks include view reports (22), edit class information (23), create new class (24), view all students (25), review student performance (26). Further functionalities include review of student information (27), review question performance (28), correspond with students (29), and view student and tutor reports (221).

The education management system enables monitoring of students' progress, provides automated or manually generated feedback, compares scores of different students in a class or across classes, assesses the quality of questions, compare performances of various classes, using the control software and data stored in the main database. The testing software in the students' computers is designed to offer the test online or offline depending on the choice of the student, store the generated data therein, and upload the information—either automatically or manually, on availability of network connectivity, whether through the Internet, local area networks or Intranet. The control software is designed to receive information from the testing software on the students' computer and store the data in the main database. The administrator can communicate with the main database using the control software. The control software enables the administrator to search the information contained in the database, retrieve desired information, send manual or automated feedback to the students based on the retrieved data.

The various functionalities of the administrator include allocation of students to specific classes based on an evaluation of their abilities and weaknesses, assignation of specific number of students to a particular tutor based on assessment of tutor capability; constant monitoring of the student progress and/or tutor effectiveness; evaluation of course content and/or specific questions in the tests administered during the program; evaluation of specific class performance by means of comparison with stored data in respect of classes conducted previously; contemporaneous modification of course content based on student requirements.

An example of education management using the system and method of the invention is given in Table 1 below:

TABLE 1

| | | | | | | | | |
|---|---|---|---|---|---|---|---|---|
| | | | | | | Average Performance | Average | |
| | | | | | | of Class in Diagnostic | Performance of | Improvement |
| Class | Tutor | Year | Subject | Course | Program | Test | Class in Test 1 | Percentage |

Comparing the performance of students in various classes (with different tutors) for the same
course

| 765 | A | 2003 | Algebra | AG101 | GMAT | 35 | 65 | 85.71 |
|---|---|---|---|---|---|---|---|---|
| 766 | B | 2003 | Algebra | AG101 | GMAT | 38 | 45 | 18.42 |
| 767 | C | 2003 | Algebra | AG101 | GMAT | 26 | 32 | 23.08 |
| 768 | D | 2003 | Algebra | AG101 | GMAT | 75 | 87 | 16.00 |
| 769 | E | 2003 | Algebra | AG101 | GMAT | 28 | 57 | 103.57 |
| 770 | F | 2003 | Algebra | AG101 | GMAT | 28 | 67 | 139.29 |
| Monitoring the change in performance when course content is | | | | | | | | |
| changed | | | | | | | | |
| 765 | A | 2003 | Algebra | AG101 | GMAT | 25 | 38 | 52.00 |
| 766 | B | 2003 | Algebra | AG101 | GMAT | 35 | 38 | 8.57 |
| 767 | C | 2003 | Algebra | AG101 | GMAT | 36 | 37 | 2.78 |
| 768 | D | 2003 | Algebra | AG102 | GMAT | 42 | 46 | 9.52 |
| 769 | E | 2003 | Algebra | AG102 | GMAT | 38 | 57 | 50.00 |
| 770 | F | 2003 | Algebra | AG102 | GMAT | 39 | 52 | 33.33 |

The classroom management system enables contemporaneous evaluation of student and tutor performance. Another advantage provided is that tutor evaluation in a classroom environment is a substantially objective and is based on student performance. The method of the invention has a high degree of standardization of evaluation parameters. The method and system of the invention are also applicable across a host of different classroom environments, whether online or in real time classroom situations.

1. A computer based education management system comprising at least one administrator computer connected to a main database through a control software, the main database being connected through the control software with at least one tutor computer and at least one student computer, the control software being provided with recognition capability for administrator, tutor and student computers, the administrator computer being enabled to carry out designated tasks; each tutor and student computer being enabled to communicate with corresponding elements in the main database using the control software.

2. A system as claimed in claim 1 wherein the student computer and the tutor computer are not required to communicate directly.

3. A system as claimed in claim 1 wherein all communication between the student and the tutor during the educational program is through the control software after securing due authentication from the administration computer.

4. A system as claimed in claim 1 wherein the student computer comprises a dedicated testing computer provided in a real time classroom environment.

5. A system as claimed in claim 1 wherein the student computer comprises a computer at a remote location.

6. A system as claimed in claim 1 wherein the tutor computer comprises a dedicated computer in a real time classroom environment.

7. A system as claimed in claim 1 wherein the tutor computer comprises a computer at a remote location.

8. A system as claimed in claim 1 wherein all communication is through a network environment.

9. A system as claimed in claim 8 wherein the network environment is selected from Internet, Intranet and a local area network.

10. A method for computer based education management enabling standardization of evaluation parameters, said method comprising administration of a diagnostic test by the system administrator to a student desirous of enrolling in the program in order to assess the level of the student, assigning a student to a specific class with a dedicated tutor based on student performance in the diagnostic test, allocating particular identification parameters to a tutor and all respective students in the class, such identification including username and password information, said identification parameters being stored in a main database using a control software through which the administrator communicates with the tutor and the students.

11. A method as claimed in claim 10 wherein the diagnostic test score is stored in the main database.

12. A method as claimed in claim 10 wherein the networking and non-direct communication between the student and the tutor are used to ensure that student requirements are met in the most optimal manner.

13. A method as claimed in claim 10 wherein a plurality of tutor and student combines are present across the same network, thereby enabling comparative evaluation of the tutors.

14. A method as claimed in claim 10 wherein the class being managed comprises an educational program selected from the group consisting of scholastic aptitude tutorials, institutional training programs and corporate training programs.

15. A method as claimed in claim 14 wherein the scholastic aptitude test is selected from the group consisting of GMAT, GRE, LSAT, SAT, TOEFL, TOEIC, corporate recruitment and evaluation tests.

16. A method as claimed in claim 10 wherein the student possesses a computer system and software which enables the student to download the tutorial content as well as tests based thereon and partake in the program offline.

17. A method as claimed in claim 16 wherein the student is enabled to download the tests, go offline, answer the tests, and upload the data manually subsequently.

18. A method as claimed in claim 16 wherein the student is enabled to download the tests, go offline, answer the tests, and data upload is carried out automatically on network connectivity.

19. A method as claimed in claim 10 wherein the system administrator utilizes access to the main database to monitor the performance of students and tutors across all the centers.

20. A method as claimed in claim 10 wherein the administrator allocates a username and password to each tutor.

21. A method as claimed in claim 20 wherein the username and password of each tutor are either generated manually by the administrator or are automatically generated.

22. A method as claimed in claim 10 wherein the administrator can also restrict the number of students allocated to any particular tutor.

23. A method as claimed in claim 10 wherein the username and password for each student is automated through the control software or generated manually by the tutor.

24. A method as claimed in claim 23 wherein the usernames of each student are used to associate the student with the allocated tutor.

25. A method as claimed in claim 10 wherein the exercise/testing software is provided to each student online in downloadable form or on computer recordable media.

26. A method as claimed in claim 25 wherein the exercise/test/assignment software contains the list of practice questions, uses adaptive/non-adaptive technology to offer the right questions to the students and an internal scoring mechanism to score the test as well register all details of the results like time taken to answer each question, percentage of questions answered right, level of the questions answered right, and the details are stored in form of identification to ensure minimum upload time.

27. A method as claimed in claim 25 wherein the test can be taken offline or online and a student needs to connect to the Internet only for authentication and to upload scores and the required data.

28. A method as claimed in claim 27 wherein the authentication is either done online or offline, depending on the requirements of the class and students, and the test results are then uploaded to the main database, and wherein the control software accepts the results and stores it in the database in the required and specified format.

29. A method as claimed in claim 10 wherein the stored data of all students in the main database enables the administrator to compare the progress of students in each class.

30. A method as claimed in claim 10 wherein the stored data of all students in the main database enables the administrator to evaluate the type and level of questions.
